(19) United States
(12) Patent Application Publication
(10) Pub. No.: US 2026/0339010 A1
(43) Pub. Date: Oct. 29, 2026

(54) OPTICAL BEAM RECEIVER ASSEMBLY

(71) Applicant: GlobalFoundries Singapore Pte. Ltd., Singapore (SG)

(72) Inventors: James You Sian TAN, Singapore (SG); Xianshu LUO, Singapore (SG)

(21) Appl. No.: 19/123,331

(22) PCT Filed: Dec. 2, 2022
(86) PCT No.: PCT/SG2022/050880

§ 371 Date: Apr. 22, 2025

(51) Int. Cl. G02B 5/28

(52) U.S. Cl. CPC G02B 5/285

(57) ABSTRACT

An optical beam receiver assembly comprising: an optical filtering layer; a beam shaping layer; and a substrate having an optical receiver, the optical filtering layer and the beam shaping layer being positioned so that the optical receiver receives an optical beam that has passed through the optical filtering layer and the beam shaping layer, wherein the optical filtering layer is configured to permit transmission of the optical beam within a wavelength range in which the optical receiver operates and attenuates other wavelengths; and wherein the beam shaping layer is configured to spatially shape an optical amplitude of the optical beam onto specific portions of the optical receiver.

### FIELD OF THE INVENTION

The present invention relates to the field of integrated photonics, target tracking and ranging, data processing and remote sensing. An optical beam receiver assembly having one or more layers and an optical receiver is disclosed, the one or more layers optimising an incident optical beam for the optical receiver.

### BACKGROUND OF THE INVENTION

An optical beam that is collected/detected by optical receivers can be non-optimal (e.g., non-homogenous), causing these receivers to be susceptible to ‘blinding effect’, or to signal loss (due to optical beam that is not detected), or that is shrouded by signal noise (due to background or atmospheric optical solar clutters). To address these problems, multiple design implementations on optical receivers itself have been proposed. However, such designs typically come with tradeoffs. It can be prohibitively complex to design a single structure that both alter, and receive the incoming optical beam at the same time.

In recent years, there have been efforts to reduce such reliance on beam receivers that concurrently receive and enhance optical beam characteristics on the same physical structure. One example of such effort is to reductionistically assign separate structures to respectively receive and enhance optical beam characteristics on separate yet integrated physical structures, for example in Zhang et al., Opt. Comm. 514, 2022. Zhang et al. discloses physically distinct yet integrated photonic components to respectively receive optical beam (in the form of photodetector), and to focus optical beam onto a spot to increase the responsibility of the photodetector (in the form of a metalens on the photodetector). Given that the optical signal detected may comprise of background noises (both from other transmitting signals and/or optical solar clutters) in addition to the main signal to be detected, the net received signal can consist a set of signals of multiple wavelengths (including that of the main signal) which introduces chromatic dispersion to the net received signal. For example, in the case of optical focusing to increase responsivity, chromatic abberation may result. This impedes accurate detection of optical beam.

It is desirable to provide an improved photonic component that addresses the above shortcomings.

### SUMMARY OF THE INVENTION

In accordance with a first aspect, there is provided an optical beam receiver assembly comprising: an optical filtering layer; a beam shaping layer; and a substrate having an optical receiver, the optical filtering layer and the beam shaping layer being positioned so that the optical receiver receives an optical beam that has passed through the optical filtering layer and the beam shaping layer, wherein the optical filtering layer is configured to permit transmission of the optical beam within a wavelength range in which the optical receiver operates and attenuates other wavelengths; and wherein the beam shaping layer is configured to spatially shape an optical amplitude of the optical beam onto specific portions of the optical receiver.

From the foregoing disclosure and following more detailed description of various embodiments it will be apparent to those skilled in the art that the present invention provides a significant advance in the technology to alter the beam characteristics of an incoming optical beam to enhance the detection of optical beam by an optical receiver system. Particularly significant in this regard is the potential the invention affords for providing enhanced beam detection not affected by dispersion. This prevents loss of signal information from the beam, which would otherwise exist due to the presence of blurring/fringes on the resulting beam. Additional features and advantages of various embodiments will be better understood in view of the detailed description provided below.

### BRIEF DESCRIPTION OF THE DRAWINGS

FIGS. 1A and 1B illustrate two implementation schematics of an optical beam receiver assembly having stacked layers;

FIGS. 2A and 2B are tables showing schematic side view of variations of discrete stacked layers for defining the beam characteristics of optical beam;

FIG. 3 is a table showing schematic isometric view of stacked layer unit cells;

FIG. 4 is a schematic isometric view of the stacked layers comprising the unit cells shown in FIG. 3 for defining the beam characteristics of optical beam;

FIG. 5 is a schematic isometric view of the stacks made up of the stack layers described in FIG. 4 for defining the beam characteristics of optical beam;

FIG. 6 is an estimated resulting transmission of optical field of additional embodiment of photonic component in stack;

FIG. 7 is a table showing an estimated resulting electric field (|E|) profiles of an array unit of stack along an xz-cross section and xy-cross section with and without the optical filtering stack of FIGS. 1A and 1B;

FIG. 8 is a table showing schematic diagrams showing beam filtering and focusing; as well as beam filtering, expansion, and focusing;

It should be understood that the appended drawings are not necessarily to scale, presenting a somewhat simplified representation of various features illustrative of the basic principles of the invention. The specific design features of the beam receiver assembly structure as disclosed here, including, for example, the specific dimensions of the stack layers, will be determined in part by the particular intended application and use environment. Certain features of the illustrated embodiments have been enlarged or distorted relative to others to help provide clear understanding. In particular, thin features may be thickened, for example, for clarity of illustration.

### DETAILED DESCRIPTION OF CERTAIN EMBODIMENTS

In the following description, various embodiments are described with reference to the drawings, where like reference characters generally refer to the same parts throughout the different views. It will be apparent to those skilled in the art, that is, to those who have knowledge or experience in this area of technology, that many use and design variations are possible for the optical beam receiver assemblies disclosed herein. The following described embodiments illustrate the general principles of the invention to provide an optical beam receiver assembly suitable for receiving and optimising an incident beam to suit applications for which its optical receiver is designed. Other embodiments suitable for other applications will be apparent to those skilled in the art given the benefit of this disclosure.

The present application relates to an integrated photonic device, specifically an optical beam receiver assembly. An optical beam receiver assembly has a multilayered structure that receives an incoming optical beam, alters its beam characteristics for its substrate to receive the resulting optical beam. The optical beam assembly may be part of an optical receiver system used in, for example, wireless communication applications.

The optical beam receiver assembly has at least the following components: one or more optical modulation layers; and a substrate with an optical receiver. The optical receiver serves to extract data in a signal carried by the incident optical beam. The optical receiver thus includes components such as one or more photodetectors and supporting infrastructure like an array of scatterers, waveguides, gratings, an array of lenses and optoelectronic switches. Alternatively, the optical receiver may be a device that integrates one or more of these components, such as a photodetector with an integrated waveguide.

The layout of the optical receiver, such as the type of photodetector, which one or more of the array of scatterers, waveguides, gratings, array of lenses and optoelectronic switches are used; and the relative position of each of them to the photodetector, may be designed for the application of the optical receiver system to which the optical beam receiver assembly belongs. For example, a LIDAR receiver system may use free-space avalanche photodetectors or waveguide-integrated avalanche photodetectors combined with on-chip waveguides integrated to an array of scatterers or gratings. While the free-space avalanche photodetectors directly enable detection of incident optical field onto the photodetectors, the array of scatterers allows optical field in free-space to be coupled to on-chip optical waveguide connected to the avalanche photodetectors. The avalanche photodetectors allow highly-sensitive detection of optical field when a high reverse bias electrical voltage (i.e., near the breakdown voltage) is applied. As a result of the high voltage applied, the electrical carriers in the transition region are accelerated, which greatly increases (in contrast to conventional photodetectors) the number of free-electron-hole pairs when the carriers produced from the incident photon collide with bound electrons.

These layout considerations result in requiring for an optical beam incident onto the optical beam receiver assembly to be spatially concentrated at certain portions of the optical receiver, depending on the optical receiver design. The operating wavelength range, required by the application for which the optical receiver system is used, is another consideration point.

The one or more optical modulation layers have at least one optical filtering layer and at least one beam shaping layer, both configured to address the above considerations and output an optical beam that is optimised for the optical receiver design.

The optical filtering layer provides a wavelength-sensitive transmission function by being configured to permit transmission of an optical beam of a predefined wavelength range and attenuating other wavelengths. By setting this predefined wavelength range to be that in which the optical receiver operates, the optical filtering layer outputs a beam that is optimised for the environment in which the optical receiver operates and also alleviates chromatic dispersion caused when there are signals of multiple wavelengths. In one implementation, the working principle of the optical filtering layer is through variation of refractive indices in the form of spatial structural arrangements comprising metals and/or dielectrics in the order larger than, comparable to, or smaller than the wavelength of the optical signal that traverses through the optical filtering layer.

In one implementation, the beam shaping layer provides a means to spatially concentrate an optical beam by being configured to spatially shape an optical amplitude of the optical beam onto specific portions of the optical receiver. This focusing concentrates the output beam into spots of significantly smaller widths compared to the original width of the incoming optical beam incident on the optical beam receiver assembly. In other implementations, the beam shaping layer expands or collimates an optical beam, rather than focusing it. As such, the beam shaping layer being configured to spatially shape an optical beam amplitude allows control of spatial amplitude distribution of the optical signal collected by the optical receiver, where depending on application, the optical receiver receives an optical beam that is focused, expanded or collimated.

The optical filtering layer, the beam shaping layer and the optical receiver are positioned so that the optical filtering layer and the beam shaping layer lie along the path of the optical beam as it propagates through the optical beam receiver assembly to reach the optical receiver. Accordingly, the optical receiver receives an optical beam that has passed through the optical filtering layer and the beam shaping layer.

The at least one optical filtering layer and the at least one beam shaping layer may be realised as thin films, corrugated thin films and/or nanostructures) positioned on or integrated to the substrate on which the optical receiver is disposed. The order of these layers may be changed. In one implementation, the beam shaping layer is disposed between the optical filtering layer and the optical receiver. The beam shaping layer may then be disposed on the optical receiver. In another implementation, the optical filtering layer is disposed between the beam shaping layer and the optical receiver. The optical filtering layer may then be disposed on the optical receiver.

The optical beam receiver assembly is described in greater detail below in conjunction with the accompanying figures.

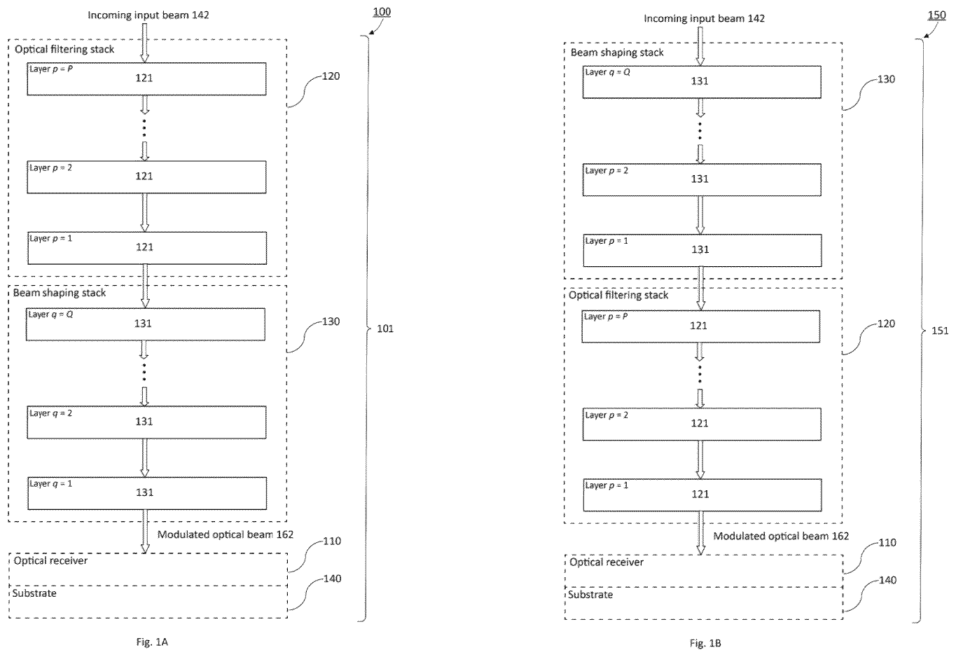

Referring to FIG. 1A, a schematic block diagram 100 of an optical beam receiver assembly 101 is disclosed which comprises at least one optical filtering layer (P≥1) 121 of an optical filtering stack 120 and at least one beam shaping layer (Q≥1) 131 of a beam shaping stack 130 mounted onto an optical receiver 110 which is positioned on a substrate 140.

The optical receiver 110 can comprise an array of free-space photodetectors, an array of scatterers (e.g., in the form of optical phased array) seamlessly connected to waveguide-integrated photodetectors, and an array of scatterers combined with lenses and optoelectronic switches (e.g., in the form of focal plane switch array) likewise seamlessly connected to waveguide-integrated photodetectors. These distinct components can be integrated onto the same platform, such as optical phased array combined with waveguide-integrated photodetectors.

The stacks (120 and 130) advantageously provides the ability to adjust the characteristics of the beam to the beam receiver structure, i.e., spatial distribution of optical amplitude. The stacks 120 and 130 may be realised by phase masks fabricated from, for example, any of silicon (Si), polysilicon, silicon nitride (Si₃N₄), silicon dioxide, germanium (Ge), lithium niobate (Li₃NbO₃) a polymer, a III-V compound (that is, an alloy containing elements from Groups III and V in the periodic table, and a II-VI compound (that is, an alloy containing elements from Groups II and VI in the Periodic Table).

There can be any arbitrary number of stack layers based on a configuration of the optical beam receiver assembly 101 selected for an application. However, while FIG. 1A shows the optical filtering stack 120 having a plurality of optical filtering layers 121 and the beam shaping stack 130 having a plurality of beam shaping layers 131, another implementation (not shown) has the optical beam receiver assembly having only one optical filtering layer and only one beam shaping layer.

The stack layers output a modulated optical beam 162 meant for the optical receiver 110 provided on the substrate 140. The modulated optical beam 162 is the result of incoming optical beam 142 being spectrally filtered by optical filtering stack 120 and spatially shaped by beam shaping stack 130 because the optical filtering layer 121 and the beam shaping layer 131 are positioned so that the optical receiver 110 receives an optical beam that has passed through the optical filtering layer 121 and the beam shaping layer 131. The optical receiver 110 can comprise structures that induce optical scattering (such as grating structures) to collectively couple a free-space optical beam to an on-chip photodetector, for example.

As seen in FIG. 1A, the optical filtering stack 120 and the beam shaping stack 130 are vertically stacked on top of one another. For instance, the first optical filtering layer p=1 is vertically stacked over by the second optical filtering layer p=2, and the second optical filtering layer p=2 is stacked over by the third optical filtering layer p=3; while the first beam shaping layer q=1 is vertically stacked over by the second beam shaping layer q=2, and the second beam shaping layer q=2 is stacked over by the third beam shaping layer q=3. The implementation of FIG. 1A uses an arrangement where the beam shaping layers 131 are disposed between the optical filtering layers 121 and the optical receiver 110. Accordingly, the first beam shaping layer q=1 is positioned above the optical receiver 110, which is in turn positioned on the chip substrate 140. The optical filtering layers 121, the beam shaping layers 131 and the optical receiver 110 are shown aligned on the chip substrate 140.

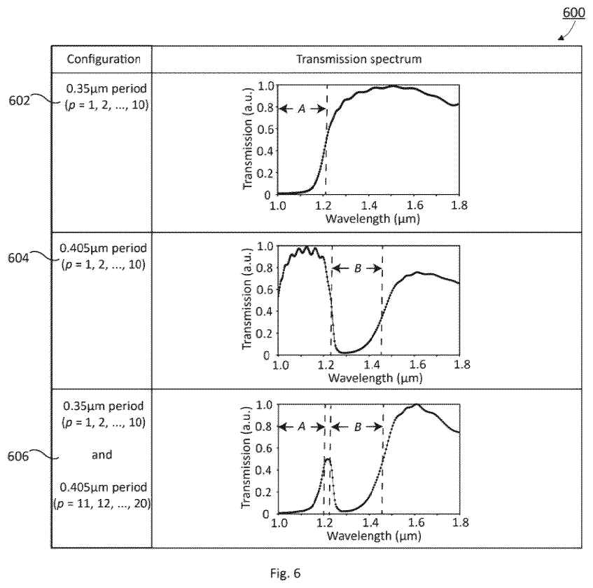

Each optical filtering layer 121 can comprise thin films of a material interleaved with thin films of a different material. One or more of the optical filter layers 121 may have different thickness or all of them may have the same thickness. Taken together, the optical filtering stack 120 comprises a plurality of optical filtering layers 121 of alternate materials of high- and low-refractive indices. Such a composition configures each optical filtering layer 121 to spectrally filter out optical signals of a certain wavelength. By selecting an appropriate combination of materials and their respective dimensions, the optical filtering stack 120 can be configured to permit transmission of an optical beam within a wavelength range in which the optical receiver 110 operates and attenuates other wavelengths using one or more optical filtering layers 121. With reference to FIG. 6, the optical filtering stack 120 may have one optical filtering layer 121 of configuration 602 that attenuates wavelength less than 1.2 m; and another optical filtering layer 121 of configuration 604 that attenuates wavelength between 1.2 m and 1.4 m. The output modulated optical beam 162 contains optical signal of wavelength more than 1.4 m.

Each beam shaping layer 131 can comprise periodically placed unit cells, each having an optical shaping element with a structure (core/pillar) having an elliptical, a polygonal, or a closed Bezier curve cross section. As such, each beam shaping layer 131 may have a plurality of optical shaping elements with such different cross sections, separated by a distance, as discussed in greater detail below. These optical shaping elements allow the beam shaping layers 131 to spatially shape optical amplitude and modify the optical beam characteristics of the optical beam. Such optical beam characteristic comprises a spatial distribution of optical amplitude. Such modulation can further comprise modulation of a beam spot size, and redistribution of optical beam for homogenous illumination, a beam width, a field of view of the optical beam, as well as to be configured to increase the responsivity of the photodetector in the optical receiver 110. Through selective incorporation of appropriate optical shaping elements which impact optical beam characteristics, the beam shaping stack 120 can be configured to reduce aberration (e.g., spherical aberration) of the focused beam, which may be introduced by the wavelength-selective transmission and attenuation performed by the optical filtering stack 120. In another configuration, the chosen optical shaping elements also facilitate collimating an optical beam to the optical receiver 100. For example, the beam shaping stack 130 may have one beam shaping layer 131 that spatially collimates the optical beam to one part of the optical receiver 110; and another beam shaping layer 131 that spatially concentrates the optical beam to another part of the optical receiver 110.

The specific (of the overall) beam characteristics may optionally be independently and/or collectively modified by multiple beam shaping layers 131. The beam shaping layers 131 may have the same, similar or distinct functionalities to define the intended optical beam characteristics. The characteristics may be sequentially modified as an optical beam propagates through each layer of the beam shaping stack 130. Each of the beam shaping layers 131 may have various attributes that can be combined in multiple ways to modulate optical beam characteristics. For example, the various dimensions of the beam shaping layers 131, including the height of their cores (i.e. where the optical beam shaping elements are located), a thickness or diameter of their cores, are selected based on phase shift required to have an optical beam focus onto particular positions of the optical receiver 110.

FIG. 1B is a schematic block diagram 150 of an optical beam receiver assembly 151 according to another embodiment of the present invention.

Similar to the optical beam receiver assembly 101 of FIG. 1A, the optical beam receiver assembly 151 has an optical filtering stack 120 having at least one optical filtering layer (P 1) 121 and a beam shaping stack 130 having at least one beam shaping layer (Q 1) 131. However, the order of the optical filtering stack 120 and the beam shaping stack 130 relative to the optical receiver 110 is different. While the optical beam receiver assembly 101 of FIG. 1A has its beam shaping layers 131 disposed between its optical filtering layers 121 and its optical receiver 110, the optical beam receiver assembly 151 of FIG. 1B has its optical filtering layers 121 disposed between its beam shaping layers 121 and its optical receiver 110. The optical filtering stack 120 of the optical beam receiver assembly 151 is mounted onto the optical receiver 110 positioned on a substrate 140.

Since the constitution of the beam shaping stack 130 and the optical filtering stack 120 of the optical beam receiver assembly 151 of FIG. 1B is the same as that of the optical beam receiver assembly 101 of FIG. 1A, they are not further elaborated.

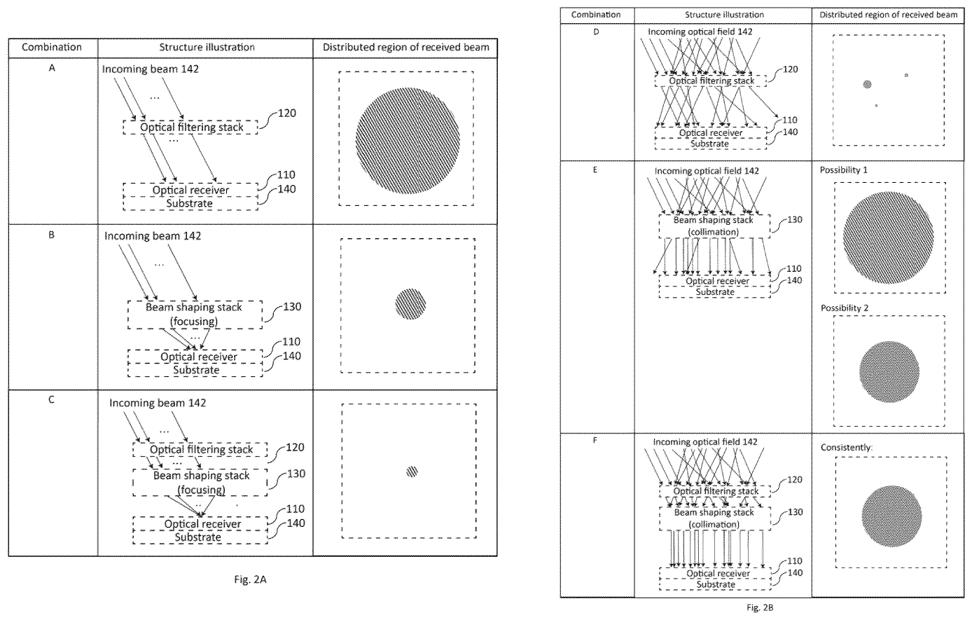

FIG. 2A and FIG. 2B are tables comparing the resulting distribution of optical beam on the beam receiver when the stacks are collectively applied, and when they are separately applied.

In FIG. 2A, in Combination A comprising optical filtering stack 120 vertically stacked on top of optical receiver 110, the beam illuminated on the optical receiver 110 has a width comparable to its width when incident onto the optical filtering stack 120. The optical filtering stack 120 does not spatially alter the amplitude distribution of the beam, but instead spectrally filters out signals of other wavelengths while only allowing signals of specific wavelength band to pass through.

In Combination B comprising beam shaping stack (e.g. in the form of a single layer metalens) 130 vertically stacked on top of optical receiver 110, the beam illuminated on the optical receiver 110 is substantially concentrated at a certain region of effective width smaller than its width when incident onto the beam shaping stack 130. The concentrated spot size is prone to being enlarged by spurious signals outside the wavelength band of interest arising from chromatic aberration as a result of unequal focal length of the metalens at different optical wavelengths.

In Combination C comprising optical filtering stack 120 vertically stacked onto beam shaping stack 130, and beam shaping stack 130 vertically stacked onto optical receiver 110, the beam illuminated on the optical receiver 110 is significantly concentrated at a sharp point of effective width markedly negligible to its width when incident onto the beam shaping stack 130. This increases the responsivity of the photodetector in the optical receiver 110, compared to the absence of such focusing. The optical filtering stack 120 selectively permits signal of specific wavelength to pass through while filtering out signals of other wavelengths, resulting in the metalens effectively focusing the spectrally filtered optical beam at equal focal lengths to result in the sharp beam focus on the optical receiver 110.

In FIG. 2B, in Combination D comprising optical filtering stack 120 vertically stacked on top of optical receiver 110, the optical field illuminated on the optical receiver 110 can be approximated as comprising random rays of light. The optical filtering stack 120 does not spatially alter the amplitude distribution of the beam, but instead spectrally filters out signals of other wavelengths while only allowing signals of specific wavelength band to pass through. As a result of the random illumination, the resulting optical field received by the optical receiver 110 is spatially random.

In Combination E comprising beam shaping stack (e.g. in the form of a single layer metalens) 130 vertically stacked on top of optical receiver 110, the optical field illuminated on the optical receiver 110, which can be approximated as comprising random rays of light, is substantially collimated at a certain region to result in a relatively uniform beam. The resulting beam is prone to being less uniformly distributed due to the presence of spurious signals outside the wavelength band of interest arising from chromatic dispersion. As a result, the resulting optical field received by the optical receiver 110 may comprise different possibilities of beam distribution.

In Combination F comprising optical filtering stack 120 vertically stacked onto beam shaping stack 130, and beam shaping stack 130 vertically stacked onto optical receiver 110, the optical field illuminated on the optical receiver 110, which can be approximated as comprising random rays of light, is highly collimated at a certain region to result in a highly uniform beam. The optical filtering stack 120 selectively permits signal of specific wavelength to pass through while filtering out signals of other wavelengths, while the beam shaping stack 130 effectively collimates the spectrally filtered optical beam to result in a highly uniform beam on the optical receiver 110. The resulting optical field received by the optical receiver 110 is of consistent beam distribution.

Both FIG. 2A and FIG. 2B illustrate advantages of the invention. The optical filter stack 120 is structurally combined/stacked with the beam shaping stack 130 to null beam distortions arising from chromatic dispersion (for example, chromatic aberration as described in Combination B). In addition to allowing focusing of an optical beam, the beam enhancement stack 130 can redefine and modify spatial amplitude distribution.

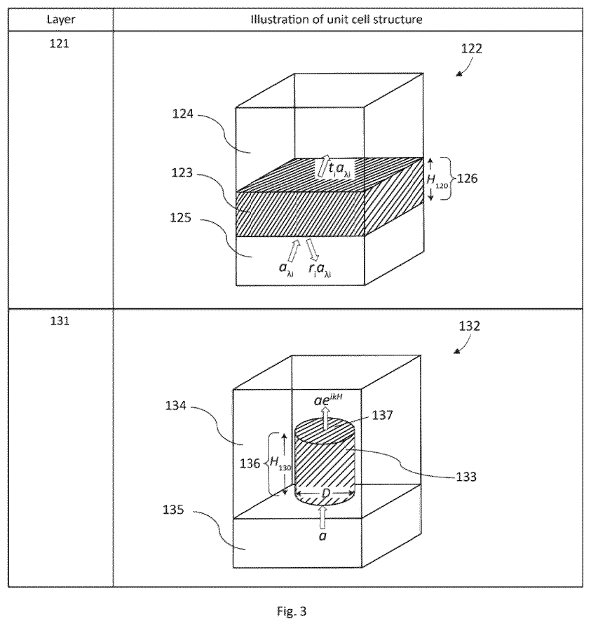

FIG. 3 is a table illustrating the unit cell structure 122 of optical filtering layer 121 of an optical filtering stack 120, and the unit cell structure 132 of beam shaping layer 131 of a beam shaping stack 130. The core 126 of the optical filtering layer 121 comprises a thin film layer surrounded by an undercladding 125 and an overcladding 124, with the core 126 extending from the undercladding 125 to the overcladding 124 by the height H120. The undercladding 125 and overcladding 124 form part of each unit cell 122 and may each comprise one or more photonic materials such as Si, polysilicon, Si₃N₄, Ge, Li₃NbO₃ a polymer, and a III-V compound. The core 133 of the beam shaping layer 131 comprises a pillar surrounded by an undercladding 135 and an overcladding 134, with the core 133 extending from the undercladding to the overcladding by the height H₁₃₀. The undercladding 135 and overcladding 134 form part of each unit cell 132 and may each likewise comprise one or more photonic materials such as Si, polysilicon, Si₃N₄, Ge, Li₃NbO₃ a polymer, and a III-V compound. Each of the cores 133 corresponding to an array of unit cells are separated by either a uniform distance (to form a symmetrical array) and a non-uniform distance. Optical filtering layer 121 stacking and beam shaping layer 131 stacking can be obtained using an overcladding which is an undercladding for the next layer of optical filtering stack 120, and beam shaping stack 130, respectively. That is, adjacent optical filter layers 121 share cladding and adjacent beam shaping layers 131 share cladding, with the cladding acting as a relay between two adjacent layers. In the beam shaping layer 131, the height of each pillar may be uniform, but the thickness and distance between each pillar may vary, for example by fixing the thickness of the overcladding, being typically 0.01 μm to 5 μm. Accordingly, one or more of these claddings (undercladding 125 and overcladding 124 for the optical filtering layer 121; and undercladding 135 and overcladding 134 for the beam shaping layer 131) may have different thickness. Such photonic components with discrete core height, fixed overcladding and undercladding thicknesses are advantageous to commercially scale and for economically sustainable mass production of the beam receiver assembly, as they can be conveniently fabricated layer-by-layer using standard fabrication techniques.

The optical filtering stack unit cell core 126 in unit cell 122 receives an optical input field of amplitude a_{λi} which is reflected by a factor of r, and transmitted by a factor of t by the core 126. When the optical filtering layers 121 that comprise unit cell 122 are taken together, the reflected parts at each layer can interfere constructively or destructively to respectively result in net low or high intensity of transmitted beam. The constructive interference results in the optical filtering layer 121 reinforcing the optical beam falling within the wavelength range the optical receiver 110 operates, while the destructive interference results in the attenuation of other wavelengths.

On the other hand, the beam shaping unit cell 132 receives an optical input field of amplitude a. The input optical field a propagates through the unit cell 132, resulting in an output optical signal ae^{ikH}₁₃₀ (by plane-wave approximation) where wavevector k=2πn_{eff}/λₒ, n_{eff} is the effective refractive index of the pillar structure, λₒ is the wavelength of the optical field. The beam shaping layer 131 is not limited to cores having two discrete levels of height (binary core), but may extend to core having multiple discrete levels of height (multilevel core), core having continuous levels of height that forms one or more continuous function curves, or core without any repeating unit.

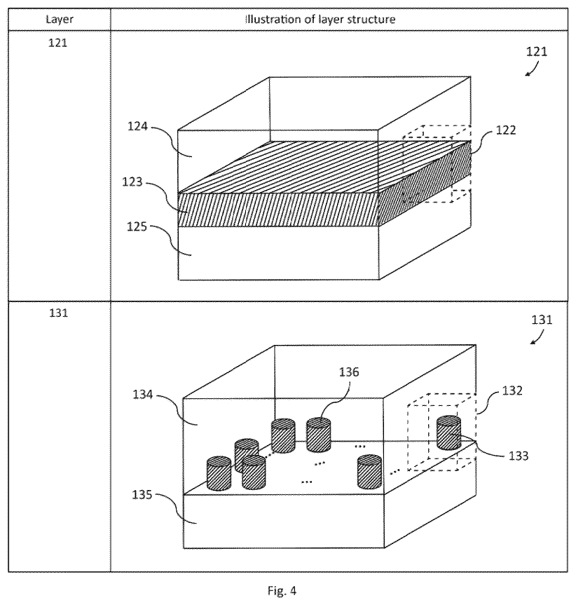

FIG. 4 is another table related to FIG. 3 showing an isometric schematic illustration of layer 121 of an optical filtering stack 120, and beam shaping layer 131 of a beam shaping stack 130. Optical filtering layer 121 and beam shaping layer 131 respectively comprise optical filtering layer unit cell 122 and beam shaping layer unit cell 132. Optical filtering layer 121 comprises thin film core 123 surrounded by undercladding 125 and overcladding 124. Beam shaping layer 131 comprises cylindrical core 136 surrounded by undercladding 135 and overcladding 134. The distance between adjacent cores of each beam shaping layer unit cell 132 may be arbitrarily chosen, and the dimensions (both height and diameter/diagonal/thickness) of the beam shaping layer unit cell 132 can be based on the intended phase shift at the particular position on the beam shaping layer 131. As such, the dimensions (one or more of height, diameter and diagonal) for each optical shaping element in the beam shaping layer 131 depends on the focus required at the position of the optical shaping element.

The distances between adjacent cores of the beam shaping layer unit cells 132 may be the same or may vary. The height of the beam shaping layer unit cell 132 can be between 0.01 μm to 10 μm, and the diameter or cross section of the core of a beam shaping layer unit cell 132 can be between 0.01 μm to 3 μm, and the periodic distance between adjacent layer unit cells 132 can be arranged in a square lattice of between 0.01 μm to 3 μm, for example. Lattice refers to regular arrangement of beam shaping layer unit cells 132, for example triangular, square or hexagonal two-dimensional lattice arrangement of beam shaping layer unit cells. Thus, optical shaping elements in the beam shaping layer 131 may be arranged in a lattice according to one of the following arrangements: triangular, square or hexagonal. Advantageously, at least one optical filtering layer 121 can be vertically stacked above at least one beam shaping layer 131; and at least one beam shaping layer 131 can be stacked above the optical receiver 110, as illustrated in FIG. 1A.

An optical phase shift at each periodic lattice point is a function of the dimension of the beam shaping layer unit cell 132. In the example shown in FIG. 4, the beam shaping layer unit cell core has a cylindrical pillar structure. The beam shaping layer unit cell 132 can be a discrete (binary) phase mask with cylindrical pillar structure of height H₁₃₀ introducing the required phase shift. Alternatively, the beam shaping layer unit cell 132 may be multilevel or may have continuous spatial heights. The cylindrical pillar structure 133 shown having an elongate top surface 137, and side walls 138 extending down from the top surface. A refractive index of the cylindrical pillar structure can be larger or smaller than the surrounding cladding, i.e. for each beam shaping layer 131, the cladding has a different refractive index from its core. In FIG. 3, the beam shaping layer unit cell 132 introduces an optical phase shift based on its binary-thickness structure. The different optical phase shifts induced by the respective beam shaping layer unit cells 132 at the different points on the beam shaping layer 131—taken together—enables optical beam to the optical receiver 110 to be judiciously tailored for specific desired requirements.

In an example, the binary thickness structure of the core 136 of the beam shaping layer unit cell 132 is a cylindrical pillar structure has a thickness of 0.4 μm (consistently discrete). The cylindrical pillar structure is surrounded by the overcladding 134 and the undercladding 135 in the unit cell 132. The beam shaping layer unit cell 132 receives an optical input field of amplitude a. The input optical field a propagates through the unit cell 132, resulting in an output optical signal ae^{ikH} (by plane-wave approximation) where wavevector k=2πn^{eff}/λₒ, n_{eff} is the effective refractive index of the pillar structure, λₒ is the wavelength of the optical field.

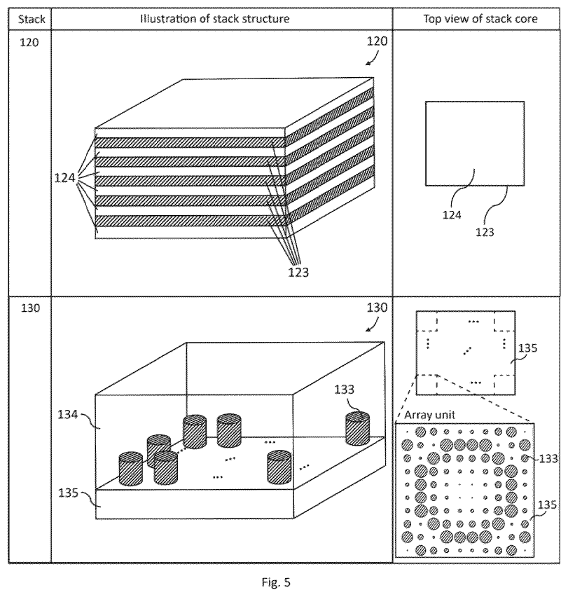

FIG. 5 is another table related to FIG. 3 and FIG. 4 showing an isometric schematic illustration of optical filtering stack 120 and beam shaping stack 130. The cores 123 of optical filtering stack 120 which comprise thin films are alternately interleaved with claddings (124 and 125). The cores 133 of beam shaping stack 130 which comprise cylindrical pillars are periodically placed. The optical phase shift at each periodic lattice point of layer 131, represented by the unit cell illustrated in FIG. 3, can be induced either by modifying k (which is a function of n_{eff}) and/or modifying H₁₃₀. In an example, n_{eff} varies with the diagonal or diameter D of the pillar structure. Advantageously, such pillar structure (which constitute the core) can be produced using standard fabrication techniques, such as lithography and deposition, and comprise photonic materials such as Si, polysilicon, Si₃N₄, Ge, Li₃NbO₃ a polymer, a III-V compound. In accordance with an embodiment, the height of each pillar in the stack layer unit cell is fixed based on layer-based deposition or etching process in a conventional semiconductor fabrication process. Advantageously, for the beam shaping layer unit cell 132, a diameter of the pillar structure is a determining factor for introducing an optical phase shift. For example, for a polysilicon cylindrical pillar having 0.4 μm thickness, surrounded by silicon dioxide overcladding and undercladding in the unit cell with 0.75 μm periodic distance between adjacent unit cells, a diameter 0 to 0.75 μm (that is, 0 to 1 times the periodic distance between adjacent unit cells) induces a monotonically increasing 0 to 2π phase shift. Thus, the intended optical phase shift at any arbitrary point on the phase mask can be designed as per choice based on the relation between the diameter and the induced optical phase shift from the diameter. In a similar manner, for metalenses, a phase profile of the optical beam is transformed based on modulo 2π operation which implies that the radii of the pillar structure in the unit cell change periodically.

In known optical receivers, the signal amplitude of incoming beam may be weak causing signal loss. Such problems can be addressed by the beam shaping layer 131 being vertically integrated above the optical receiver 110 to define and modify the spatial distribution of optical amplitude of the optical beam, that is to spatially focus the beam to points of interest(s) on the optical receiver 110. As a result of spatial focusing by the beam shaping stack 130, incident photon flux at the points of interest(s) increases. This leads to increase in absorbed optical field from the beam to generate more electron-hole pairs which increases the responsivity (ratio of electrical current to optical power) of the photodetector on the optical receiver 110, for example. The beam shaping layer 131 for beam focusing is designed such that optical phase of each horizontally adjacent beam shaping layer unit cell 132 is shifted by

$${Δφ}_{i + 1} = \frac{2 π}{{λ}_{i + 1 , i + 2}} Δ r \qquad ( 1 )$$

where \sqrt{Δr=x²+f²}−f for line focus and \sqrt{Δr=x²+y²+f²}−f for point focus;
x and y (i.e., that is perpendicular to x) are the distances that correspond to Δr

In known optical receivers integrated with beam focusing structures, the beam focused onto the optical receivers, for example free-space photodetectors, are prone to having increased beam width due to the presence of optical signals of different optical wavelengths. Such aberration is especially pronounced in settings where optical signals from various different sources are present, and/or when the main signal to be detected—after traversing in free-space—is dampened which increases the signal-to-noise ratio. Such problems can be addressed by the optical filtering stack 120 being vertically integrated above the beam focusing layer 131 and optical receiver 110 (as illustrated in FIG. 1A) to spectrally filter out signals of other wavelengths and allow main signal(s) of interest which are of particular wavelength(s). As a result of the spectral selectivity of the optical filtering stack 120, the incident beam to the beam focusing layer 131 comprises signal of certain wavelength(s). The resulting beam from the beam focusing layer 131 can thus be directed ‘chromatic aberration-free’ to certain spatial point(s) of interest resulting in an increase in responsivity of the free-space photodetector on the optical receiver 110. The increase in optical-to-electrical conversion efficiency directly indicates increased detection sensitivity, which is desirable for many beam detection applications including LiDAR and free-space transceivers.

FIG. 6 illustrates finite-difference time-domain (FDTD) numerical simulation results for optical filtering using vertical stacking of optical filtering stack on an optical receiver. The numerically simulated optical filtering stack 600 has defined parameters, such as ten layers of 100 nm polysilicon thin film layers alternately interleaved with 250 nm silicon dioxide (SiO₂) thin film layers (i.e., 0.35 μm spatial period) in configuration 602 to filter optical signal at wavelength range A, and ten layers of 100 nm polysilicon thin film layers alternately interleaved with 305 nm silicon dioxide (SiO₂) thin film layers (i.e., 0.405 μm spatial period) in configuration 604 to filter optical signal at wavelength range B. Different layer configurations can be stacked to combine the filtered signal range (both optical wavelength range A and B in configuration 606). The optical filtering stack 600 is provided with air in the region beyond the topmost layer SiO₂ overcladding. The beam directionality to optical filtering stack is 14.5°. The periodic variations of refractive indices in the optical filtering stack 600 results in a spectral stopband (negligible optical transmission) centered at ~550 nm wavelength with a ~250 nm stopband spectral width. Other variations in center stopband wavelength and stopband spectral width can be attained with modifications to the materials and structural dimensions of the optical filtering stack. Multiple set of layers which form the optical filtering stack with various stopband attributes (e.g., different stopband wavelengths) may be combined in multiple ways to provide a net range of stopband center wavelengths and stopband spectral widths.

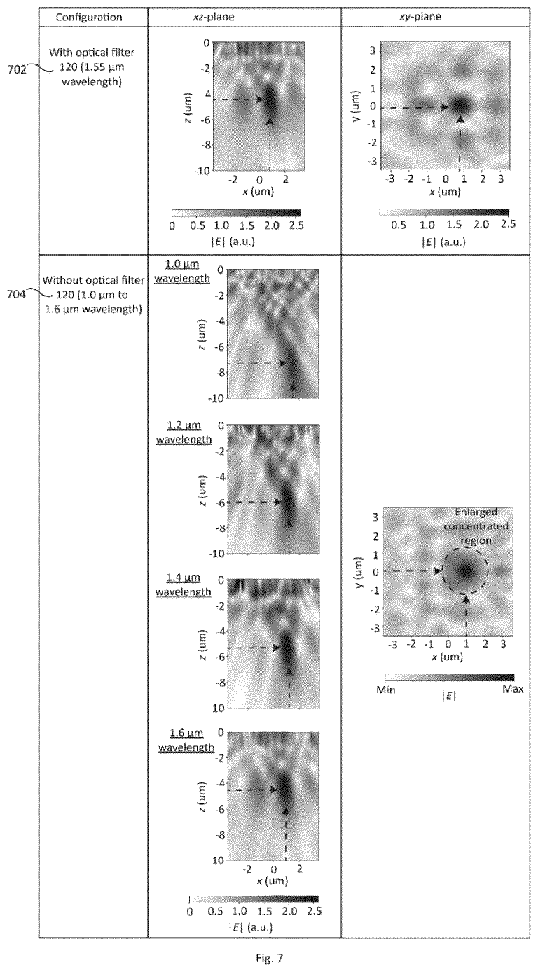

FIG. 7 is a table with an estimated resulting electric field magnitude (|E|) profiles of additional array units of beam shaping stack 130 along an xz-cross section and xy-cross section both with 702 and without 704 optical filtering stack 120.

In the example 702, the numerically simulated metalens array unit cell which forms the optical beam shaping stack 120, has defined parameters, such as 0.5 μm thick cylindrical pillar polysilicon structure as the phase mask unit cell at pitch d=0.65 μm, with radius ranging from (0.275 to 0.475)×d to represent 2π phase shift. Each layer is also provided with an overcladding of 0.25 μm-thick (between the unit cell cores) silicon dioxide, and air in the region beyond the topmost layer overcladding. The beam directionality to optical filtering stack 120 is 14.5°. The metalens array has a focal length of ~4.5 μm at 1.55 μm, centred at Δx=1 μm and Δy=0 from the centre of the array unit cell. In the configuration 704 without optical filtering stack 120, optical signal of optical wavelength of 1.0 μm to 1.6 μm is let incident onto the beam shaping stack 130 for beam focusing. At these wavelengths, the focal length of the metalens array varies from ~4.5 μm to ~7.5 μm, which results in an enlarged concentrated region at a certain distance from the beam shaping stack 130 (here, at 4.5 μm).

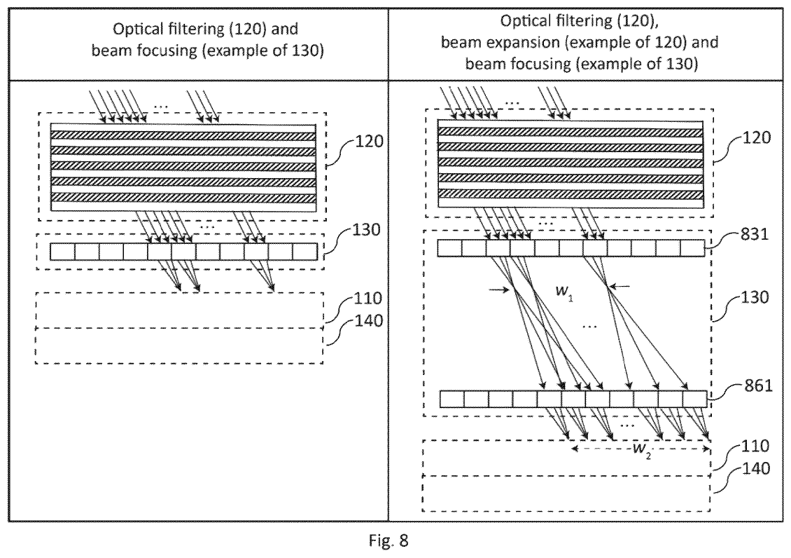

The beam shaping stack 130 may include beam shaping layers with the same and/or distinct functionalities to simultaneously achieve the same, similar or distinct functionalities to modify the beam characteristics. For example, the beam shaping stack 130 may comprise beam shaping layers having beam focusing and beam expansion functionalities combined in multiple ways, with an example shown in FIG. 8. Both the beam expansion layer 831 and beam focusing layer 861 of the beam shaping stack 130 may be advantageously produced from metalens array, with array unit cell illustrated in FIG. 5, and estimated resulting electric field magnitude (|E|) profiles shown in FIG. 7.

The beam expansion layer 831 which comprises metalens array cells expands the width of the beam from that is incident on the layer. This results in an increase in the net width of the beam from w₁ to w₂ after it traverses through beam focusing layer 861, with the widened beam being less spatially concentrated. Thus, the devices disclosed herein are scalable and provide flexibility in vertically integrating beam shaping layers on the optical receiver 110, and use discretized phase shift unit cells (that is, beam shaping layer unit cells) to modify the beam characteristics to the optical receiver 110. Different stack layers having the same, similar or distinct functionalities which can be used by vertically integrating them above the optical receiver 110 thereby achieve multifunctional layers (feature integration) on a single integrated platform.

Further, the optical receiver 110 with vertically stacked layers is compact, and integration is fully achieved on the substrate 140. The beam shaping stack 130 can also be positioned precisely via chip design without requiring any mechanical positioning thereby enabling a robust system less prone to mechanical errors. The optical receiver 110 is also cost-efficient as the platform is integrated entirely on chip and additional stacked layers can be conveniently added using the same fabrication steps. Such convenience to fabricate additional stacked layers enables bulk production of such devices thereby improving cost efficiency.

From the foregoing disclosure and detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An optical beam receiver assembly comprising:
an optical filtering stack;
a beam shaping stack; and
a substrate having an optical receiver, the optical filtering stack and the beam shaping stack being positioned so that the optical receiver receives an optical beam that has passed through the optical filtering stack and the beam shaping stack,
wherein the optical filtering stack is configured to permit transmission of the optical beam within a wavelength range in which the optical receiver operates and attenuates other wavelengths;
wherein the optical filterinq stack is disposed on the beam shapinq stack;
wherein the optical filterinq stack consists of dielectric material;
wherein the beam shaping stack comprises optical shapinq elements configured to induce a phase shift to spatially shape an optical amplitude of the optical beam onto specific portions of the optical receiver; and
wherein the beam shapinq stack has uniform thickness and consists of dielectric material.

2. (canceled)

3. (canceled)

4. The optical beam receiver assembly of claim 1, wherein the optical filterinq stack comprises a plurality of optical filter layers.

5. The optical beam receiver assembly of claim 4, wherein the plurality of the optical filter layers alternate between materials of high and low refractive indices.

6. The optical beam receiver assembly of claim 4, wherein one or more of the optical filter layers have different thickness.

7. The optical beam receiver assembly of claim 4, wherein adjacent optical filter layers share cladding.

8. The optical beam receiver assembly of claim 7, wherein the cladding has a different refractive index from a core of each of the adjacent optical filter layers.

9. The optical beam receiver assembly of claim 7, wherein one or more of the claddings has different thickness.

10. The optical beam receiver assembly of claim 1, wherein the optical filtering stack reinforces the optical beam falling within the wavelength range the optical receiver operates.

11. The optical beam receiver assembly of claim 1, further comprising a plurality of the beam shaping layers.

12. The optical beam receiver assembly of claim 1, wherein the beam shaping layer comprises optical shaping elements with one or more of the following cross sections: elliptical, polygonal, or a closed Bezier curve.

13. The optical beam receiver assembly of claim 12, wherein the optical shaping elements are arranged in a lattice according to one of the following arrangements: triangular, square or hexagonal.

14. The optical beam receiver assembly of claim 12, wherein each optical shaping element dimensions depends on focus required at the optical shaping element position.

15. The optical beam receiver assembly of claim 14, wherein one or more of the optical shaping elements have different dimensions comprising one or more of height, diameter and diagonal.

16. The optical beam receiver assembly of claim 11, wherein adjacent beam shaping layers share cladding.

17. The optical beam receiver assembly of claim 16, wherein the cladding has a different refractive index from a core of each of the adjacent beam shaping layers.

18. The optical beam receiver assembly of claim 16, wherein one or more of the claddings has different thickness.

19. The optical beam receiver assembly of claim 1, wherein the optical receiver comprises one or more of: an array of free-space photodetectors, an array of scatterers, waveguide-integrated photodetectors, an array of lenses and optoelectronic switches, and gratings.
